(19) United States
(12) Patent Application Publication
(10) Pub. No.: US 2004/0138402 A1
(43) Pub. Date: Jul. 15, 2004

(54) Two component polyurethane adhesive for wooden materials

(76) Inventors: Lothar Thiele, Langenfeld (DE); Bernhard Gruenewaelder, Hilden (DE); Andre Te Poel, Willich (DE); Hans-Peter Kohlstadt, Velbert (DE)

Correspondence Address: HENKEL CORPORATION, THE TRIAD, SUITE 200, 2200 RENAISSANCE BLVD., GULPH MILLS, PA, 19406, US

(21) Appl. No.: 10/644,045

(22) Filed: Aug. 19, 2003

Related U.S. Application Data
(63) Continuation of application No. PCT/EP02/01370, filed on Feb. 9, 2002.

(30) Foreign Application Priority Data
Feb. 19, 2001 (DE) 101 08 025.5

(51) Int. Cl. C08G 18/00

(52) U.S. Cl. 528/74.5; 528/85

(57) ABSTRACT

A two-component polyurethane adhesive for adhesively bonding wooden materials based on a polyol component A consisting of

a) 10 to 98 wt. % of at least one oleochemical polyol,

b) 1 to 7.5 wt. % of at least one diol having a hydroxyl value of 400 to 2000 and

c) 1 to 7.5 wt. % of at least one tri-, tetra- or pentafunctional polyol having a hydroxyl value of 200 to 2000, the wt. % of each of a), b) and c) is based on the whole of the polyol mixture, and

a polyisocyanate component B), wherein the NCO/OH ratio of components A) and B) is within the range of 1.5 to 0.9. The addition to the polyol component of 0 to 60 wt. %, based on the total weight of the polyol mixture, of a homogeneously dissolved resin, brings about a sharp increase in the adhesive strength. The adhesive maintains its strength even after boiling for 24 hours and drying for 7 days at 60° C. The adhesive is highly suitable for loadbearing structural members made of wood.

### CROSS REFERENCE TO RELATED APPLICATIONS

This application is a continuation under 35 USC 365(c) and 35 USC 120 on international application PCT/EP02/01370, filed on Feb. 9, 2002, the international application not being published in English. This application also claims priority under 35 USC 119 to DE 101 08 025.5, filed on Feb. 19, 2001.

### BACKGROUND OF THE INVENTION

This invention relates to a two-component polyurethane as well as its use for bonding wood and wooden materials, especially loadbearing wooden structures.

Polyurethane adhesives are well known. DE 44 01 572 A1 describes two-component polyurethane adhesives based on an isocyanate component and on a polyol component, which contain an oleochemical polyol and in addition 2 to 7 per cent by weight, based on the oleochemical polyol, of at least one di- and/or trifunctional alcohol, the hydroxyl value of the alcohols or the mixtures thereof being 1,100 to 1,850. These compositions can be used for bonding rigid or flexible substrates, in particular plastics, metals, glass or, particularly preferably, wood, for bonding both combinations of these substrates to one another and one of these substrates to the identical substrate. The wood adhesives comply with the Standard EN 205 “Assessment of adhesives for non-loadbearing structural members for the bonding of wood and wooden materials”. More precisely, they comply not only with the requirements of the stress group D3, but in some cases also with those of D4. For this, the wood adhesive was stored for 7 days in a standard environment (20° C./65% relative humidity), for 6 hours in boiling water and for 2 hours in water at a temperature of 20° C. After this, the combined tensile and shear strength in one of the three Examples was still 4.5 N/mm2. In order to comply with the Standard, a value of more than 4 N/mm2 is required. Thus the known invention just fulfils this requirement for D4 materials in a few cases. The known adhesive is very suitable for non-loadbearing wooden structural members, but not for loadbearing ones.

Polyurethane adhesives for loadbearing wooden structural members are also known. DE 44 12 759 A1 describes a one-component polyurethane adhesive which is distinguished by a content of:

a) 50 to 95 wt. % of an isocyanate-containing polyurethane prepolymer,

b) 2 to 8 wt. % of a hydrophobic silicon dioxide and

c) 2 to 6 wt. % of a pulverulent molecular sieve

as well as optionally by other conventional additives and/or accelerators. The minimum pressing time required to attain the initial bonding is 9 hours. The final strength was attained after 2 to 3 days. No tests which would confirm suitability for loadbearing structural members were presented; in particular, no tensile tests after a treatment in boiling water were described. Another disadvantage is the long pressing time. The short pressing times of two-component adhesives based on polyurethane are not in principle attainable with one-component polyurethane adhesives.

Thus, the object of the present invention is to provide an adhesive for loadbearing structural members made of wood or wooden materials which, as regards handling, storage and use behaves like a two-component polyurethane adhesive, but as regards its adhesive properties complies with the requirements for loadbearing structural members. In particular, the combined tensile and shear strength after 24 hours in boiling water and after drying for 7 days at 60° C. decreases by less than 40%, and especially by less than 20%.

The solution, according to the invention, is the use of a resin, which is homogeneously dissolved in the polyol mixture.

### DETAILED DESCRIPTION OF THE INVENTION

The invention accordingly provides a two-component polyurethane adhesive for wooden materials, based on

A) a polyol mixture, containing at least

a) 10 to 98 wt. %, in particular 20 to 95 wt. %, of at least one oleochemical polyol,

b) 1 to 7.5 wt. %, in particular 2 to 5 wt. %, of at least one diol having a hydroxyl value of 400 to 2000, in particular 500 to 1800 and

c) 1 to 7.5 wt. %, in particular 2 to 5 wt. %, of at least one trifunctional or higher functional, in particular a tri-, tetra- or pentafunctional polyol having a hydroxyl value of 200 to 2000, in particular 400 to 1850, each of a), b) or c) is based on the total weight of the polyol mixture, and

B) at least one polyisocyanate, wherein the NCO/OH ratio of components A) and B) is within the range of 1.5 to 0.9, in particular 1.3 to 0.9, and from 0 to 85 wt. %, in particular 10 to 70 wt. %, based on the whole of the adhesive, of at least one auxiliary substance,

wherein the polyol mixture contains 0 to 60 wt. %, in particular 10 to 50 wt. %, based on the whole of the polyol mixture, of a resin homogeneously dissolved therein.

“Based on” means that components A (polyol mixture) and B (polyisocyanates) are essential constituents of the adhesive, which are also optionally modifiable by the auxiliary substances. The invention also provides the polyol mixture A alone, as it can be cured both by isocyanates and by epoxides. The reaction is preferably carried out using polyisocyanates.

By “oleochemical polyols” are meant polyols based on natural oils and fats, for example, the reaction products of epoxidised fatty substances with mono, di- or polyfunctional alcohols; or glycerol esters of long-chain fatty acids which are at least partially substituted with hydroxyl groups.

A subgroup of these compounds comprises the products of the ring opening of epoxidised triglycerides, that is, epoxidised glycerol esters of fatty acids, wherein the ring opening has been carried out with the preservation of the ester bonds. To prepare the products of ring opening, it is possible to start from a multitude of epoxidised triglycerides of vegetable or animal origin. Thus, for example, epoxidised triglycerides which contain 2 to 10 per cent by weight of epoxide oxygen are suitable. Such products are obtainable by epoxidation of the double bonds of a number of fats and oils, for example, beef fat, palm oil, peanut oil, rapeseed oil, cottonseed oil, soya oil, sunflower oil and linseed oil. Particularly preferred epoxidised triglycerides are epoxidised soya oil and epoxidised linseed oil.

Alcohols which can be used for the ring opening of the epoxidised triglycerides are methanol, ethanol, propandl, isopropanol, butanol, hexanol, 2-ethylhexanol, fatty alcohols having 6 to 22 C atoms, cyclohexanol, benzyl alcohol, 1,2-ethanol, 1,2-propanediol, 1,3-propanediol, 1,4-butanediol, 1,6-hexanediol, neopentyl glycol, trimethylolpropane, glycerol, trimethylolethane, pentaerythritol, sorbitol as well as hydroxy compounds containing ether groups and alkyl glycols or oligomeric glycols as well as oligomeric glycerols.

The ring-opening reaction of epoxidised esters of fatty acids or triglycerides by means of an alcohol may optionally be followed by a transesterification with itself or with other, subsequently introduced triglycerides such as, for example, palm oil, peanut oil, rapeseed oil, cottonseed oil, soya oil, sunflower oil and linseed oil. Such oleochemical polyols are described, for example, in the German Patent Application DE-A1 41 28 649.

Another type of oleochemical polyol comprises the products of the ring opening and transesterification of epoxidised fatty acid esters of lower alcohols, that is, of epoxidised methyl, ethyl, propyl or butyl esters of fatty acids. Here the products of ring opening or transesterification using alcohols having a functionality of 2 to 4 are preferred, in particular the reaction products with ethylene glycol, propylene glycol, oligomeric ethylene glycols, oligomeric propylene glycols, glycerol, trimethylolpropane or pentaerythritol. Such products can be prepared by known methods of epoxidation and ring opening, and the transesterification can be carried out during or after the ring-opening step, by removal of the lower alcohol from the reaction equilibrium. Preferred compounds are the products of ring opening and transesterification wherein the epoxidised fatty acid ester and the alcohol employed for the reaction have been used in a molar ratio to one another of 1:1 to 1:10.

The oleochemical polyols also include the reaction products of epoxidised fatty alcohols with C2-C8-alcohols having a functionality of 1 to 10, in particular 2 to 4, in the molar ratio of epoxide rings to hydroxyl groups of 1:1 to 1:10.

The use of oleochemical polyols which are accessible via the transesterification of difunctional or polyfunctional alcohols—such as, for example, the addition product of ethylene oxide or propylene oxide to glycerol—with triglycerides, for example, palm oil, peanut oil, rapeseed oil, cottonseed oil, soya oil, sunflower oil and linseed oil is also within the scope of the invention.

Equally, one may also use polyols which, according to the instruction in DE-A1 41 24 665, are obtainable by the transesterification of polymerised glycerol with the above-mentioned triglycerides.

The polyols may have hydroxyl values of 50 to 400, preferably of 100 to 300.

The use of castor oil and of dimeric diols produced by Henkel KGaA as oleochemical polyols is particularly preferred, as are the polyester polyols prepared by complete ring opening of epoxidised triglycerides of an at least partially olefinically unsaturated mixture of fats containing fatty acid with one or more alcohols having 1 to 12 C atoms, and subsequent partial transesterification of the triglyceride derivatives to form alkyl ester polyols having 1 to 12 C atoms in the alkyl group.

The term “at least one diol having a hydroxyl value of 400 to 2000” means both one diol and a mixture of diols having hydroxyl values within this range. Here the individual components of the mixture are not each required to have a hydroxyl value within the above-mentioned range; rather, the use of a mixture of diols wherein the individual hydroxyl values lie outside the claimed range is also possible. The diols include in particular alkanediols having 2 to 6 C atoms, the alkane possibly being linear, branched or cyclic. For example, 1,2-propanediol, 1,3-propanediol, 2,3-butanediol or 2,4-butanediol as well as diglycol and dipropylene glycol are usable, in particular 1,4-butanediol, dipropylene glycol and diglycol.

The term “trifunctional or higher functional polyols” means both individual compounds and mixtures thereof. Here, too, the polyol mixture should have the specified hydroxyl value of 200 to 2000; the individual higher functional polyol may also be outside this range. Polyols having 3, 4 or 5 OH groups, such as glycerol, triethanolamine, pentaerythritol, propoxylated or ethoxylated ethylenediamine, are particularly preferred. However, trimethylolpropane, trimethylolethane or addition products of one mol of ethylene oxide to glycerol are also usable. Polyols having 4 OH groups (tetraols) are especially preferred.

Besides these low-molecular diols and higher functional polyols, the polyols of higher molecular weight which are conventional in PU production can also be used in a quantity of 0 to 70 wt. %, in particular 0 to 50 wt. %, based on the whole of the polyol component. Suitable polyols of higher molecular weight are preferably liquid polyhydroxy compounds, in particular those having two or three hydroxyl groups per polyether molecule and/or polyester molecule such as, for example, di- and/or trifunctional polypropylene glycols having molecular weights in the range of 200 to 6000, preferably in the range of 400 to 3000. Statistical and/or block copolymers of ethylene oxide and propylene oxide can also be used. Another type of preferably used polyether polyol comprises the polytetramethylene glycols, which are prepared, for example, by the acidic polymerisation of tetrahydrofuran. Here the molecular weights of the polytetramethylene glycols are in the range of 200 to 6000, preferably in the range of 400 to 4000. Other compounds which are suitable as polyols are the liquid polyesters which can be prepared by condensation of di- or tricarboxylic acids such as, for example, adipic acid, sebacic acid and glutaric acid, with low-molecular diols or triols such as, for example, ethylene glycol, propylene glycol, diethylene glycol, triethylene glycol, dipropylene glycol, 1,4-butanediol, 1,6-hexanediol, glycerol or trimethylolpropane.

Other types of polyols which may optionally be used are the polyesters based on c-caprolactone, also referred to as “polycaprolactones”, and polycarbonate polyols.

The polyisocyanates are polyfunctional. The suitable polyfunctional isocyanates preferably contain on average 2 to at most 5, preferably up to 4 and in particular 2 or 3, NCO groups. Examples of suitable isocyanates which may be mentioned are phenyl isocyanate, 1,5-naphthylene diisocyanate, 4,4′-diphenylmethane diisocyanate (MDI), hydrogenated MDI (H12MDI), xylylene diisocyanate (XDI), m- and p-tetramethyl xylylene diisocyanate (TMXDI), 4,4′-diphenyldimethylmethane diisocyanate, di- and tetraalkyldiphenylmethane diisocyanate, 4,4′-dibenzyl diisocyanate, 1,3-phenylene diisocyanate, 1,4-phenylene diisocyanate, the isomers of tolylene diisocyanate (TDI), optionally in a mixture, 1-methyl-2,4-diisocyanatocyclohexane, 1,6-diisocyanato-2,2,4-trimethylhexane, 1,6-diisocyanato-2,4,4-trimethylhexane, 1-isocyanatomethyl-3-isocyanato-1,5,5-trimethylcyclohexane (IPDI), chlorinated and brominated diisocyanates, phosphorus-containing diisocyanates, 4,4′-diisocyanatophenylperfluoroethane, tetramethoxybutan-1,4-diisocyanate, butane-1,4-diisocyanate, hexane-1,6-diisocyanate (HDI), dicyclohexylmethane diisocyanate, cyclohexane-1,4-diisocyanate, ethylene diisocyanate, phthalic acid bisisocyanatoethyl ester, also polyisocyanates having reactive halogen atoms, such as 1-chloromethylphenyl-2,4-diisocyanate, 1-bromomethylphenyl-2,6-diisocyanate, 3,3-bischloromethyl ether 4,4′-diphenyl diisocyanate. Sulfur-containing polyisocyanates are obtained, for example, by reacting 2 mol of hexamethylene diisocyanate with 1 mol thioglycol or dihydrodihexyl sulfide. Other important diisocyanates are trimethylhexamethylene diisocyanate, 1,4-diisocyanatobutane, 1,12-diisocyanatododecane and dimeric fatty acid diisocyanate.

Compounds which merit interest are partially capped polyisocyanates, which make possible the formation of self-crosslinking polyurethanes, for example, dimeric tolylene diisocyanate, or polyisocyanates partially or completely reacted with, for example, phenols, tertiary butanol, phthalamide, caprolactam.

In a particular embodiment, the isocyanate component contains a proportion of dimeric fatty acid isocyanate. By dimeric fatty acid is meant a mixture of predominantly C36-dicarboxylic acids, which is prepared by thermal or catalytic dimerisation of unsaturated C18-monocarboxylic acids, such as oleic acid, tall-oil fatty acid or linoleic acid. Such dimeric fatty acids have long been known to the person skilled in the art and are commercially obtainable. The dimeric fatty acid can be converted into dimeric fatty acid isocyanates. Technical dimeric fatty acid diisocyanate possesses on average at least two and less than three isocyanate groups per molecule of dimeric fatty acid. Preferably the isocyanate component a) consists to the extent of more than 30 wt. %, in particular at least predominantly and preferably completely, of aromatic isocyanates such as MDI.

Aromatic isocyanates, and equally oligomerised NCO-terminal adducts of the above-mentioned isocyanates and polyols, polyamines or aminoalcohols, are generally preferred. However, contrary to expectation, aliphatic and cycloaliphatic isocyanates are also able to react rapidly and completely even at room temperature.

Partially capped polyisocyanates, which make possible the formation of self-crosslinking polyurethanes, for example, dimeric tolylene diisocyanate, also merit interest. Finally prepolymers, and thus oligomers having several isocyanate groups, may also be used. As is generally known, they are obtained with a large excess of monomeric polyisocyanate in the presence of, for example, diols. Isocyanuratisation products of HDI and biuretisation products of HDI are also possible.

The di- or polyisocyanates used are preferably the aromatic isocyanates, for example, diphenylmethane diisocyanate, either in the form of the pure isomers, as an isomeric mixture of the 2,4′-/4,4′-isomers or else diphenylmethane diisocyanate (MDI) liquefied with carbodiimide, which is known, for example, under the trade name Isonate 143 L, as well as the so-called “crude MDI”, i.e. the mixtures of isomers or oligomers of MDI, which are obtainable commercially, for example, under the trade name PAPI or Desmodur VK. One may also use so-called “quasi-prepolymers”, i.e. reaction products of MDI or of tolylene diisocyanate (TDI) with low-molecular diols such as, for example, ethylene glycol, diethylene glycol, propylene glycol, dipropylene glycol or triethylene glycol. Aliphatic, cycloaliphatic or aromatic isocyanates having a functionality of 2 to 4 are preferred.

The ratio of the isocyanate groups contained in the isocyanate component to the OH groups contained in the polyol component is usually in the region of equivalence, but in view of the water present in the wood, a slight excess of isocyanate groups is advisable.

The two-component polyurethane adhesives according to the invention may also contain auxiliary substances, which preferably are completely or partially admixed to the polyol component. By these are meant substances which (except for fillers) are usually added in small quantities in order to modify the properties of the essential components in the required direction, for example, to accommodate their workability, stability in storage and also properties in use to the particular field of application. Usable auxiliary substances may be: fillers, flow-control agents, deaerators, thixotropic agents, catalysts, antioxidants, dyes, drying agents, flameproofing agents, solvents and wetting agents. Suitable fillers are inorganic compounds which do not react with isocyanates, such as chalk, coated chalk, lime powder, calcium magnesium carbonates, aluminum oxides and hydroxides, precipitated silica, zeolites, bentonites, glass, hollow spheres, ground minerals and other inorganic fillers known to the specialist actively employed in this area of work. The preferred filler is chalk, modified or unmodified.

The flow-control agent promotes the flow of the adhesive during application, i.e. its capacity to level out unevennesses, streaks, bubbles, craters et cetera which appear during application. Suitable flow-control agents are unreactive compounds such as glycol ethers, silicone oils, acrylic copolymers, esters, ketones and terpene solvents having a medium to high relative evaporation rate. Preferred flow-control agents are: Perenol F 3 and Perenol F 40 (polyacrylate), Perenol S 4 (modified polysiloxane), Perenol S 43 (polysiloxane copolymer) and BYK-S 706 (polyacrylate). The so-called deaerators have a similar action, with the following products being preferred: Perenol E 1 (polyvinyl derivative), Perenol E 7 (organic polymer with a trace of silicone), Perenol E 8 (solvent mixture with silicone component), Perenol F 40 (solvent mixture with silicone component), Perenol F 45 (copolyacrylate) and BYK-A types (modified polysiloxanes, sometimes mixed with other polymers).

The two-component polyurethane adhesives according to the invention may also contain catalysts which accelerate the reaction of the OH group with the NCO groups, mainly organometallic compounds such as tin(II) salts of carboxylic acids, strong bases such as alkali hydroxides, alkali alkoxides and alkali phenolates, for example, di-n-octyltin mercaptide, dibutyltin maleate, dibutyltin diacetate, dibutyltin dilaurate, dibutyltin dichloride, dibutyltin bisdodecyl mercaptide, tin(II) acetate, tin(II) ethylhexoate and tin(II) diethylhexoate or lead phenylethyl dithiocarbaminate. Trimerisation catalysts which may be mentioned are DABCO TMR-2 et cetera, manufactured by Air Products; these are quaternary ammonium salts dissolved in ethyl glycol.

Besides these, aliphatic tertiary amines, in particular those having a cyclic structure, are also suitable. Among the tertiary amines, those having in addition further groups which are reactive with the isocyanates, in particular hydroxyl and/or amino groups, are also suitable. The following may be particularly mentioned: dimethylmonoethanolamine, diethylmonoethanolamine, methylethylmonoethanolamine, triethanolamine, trimethanolamine, tripropanolamine, tributanolamine, trihexanolamine, tripentanolamine, tricyclohexanolamine, diethanolmethylamine, diethanolethylamine, diethanolpropylamine, diethanolbutylamine, diethanolpentylamine, diethanolhexylamine, diethanolcyclohexylamine, diethanolphenylamine as well as their ethoxylation and propoxylation products, diazabicyclooctane (Dabco), triethylamine, dimethylbenzylamine (Desmorapid DB, BAYER), bis(dimethylamino)ethyl ether (Catalyst A 1, UCC), tetramethylguanidine, bis(dimethylamino)methylphenol, 2,2′-dimorpholinodiethyl ether, 2-(2-dimethylaminoethoxy)ethanol, 2-dimethylaminoethyl-3-dimethylaminopropyl ether, bis(2-dimethylaminoethyl) ether, N,N-dimethylpiperazine, N-(2-hydroxyethoxyethyl)-2-azanorborane, Texacat DP-914 (Texaco Chemical), N,N,N,N-tetramethyl-1,3-butanediamine, N,N,N,N-tetramethyl-1,3-propanediamine and N,N,N,N-tetramethyl-1,6-hexanediamine.

The catalysts may also be in oligomerised or polymerised form, for example, as nitrogen-methylated polyethylenimine. According to the invention, a resin is added to the polyol mixture. Here the resins are liquid to solid organic products, characteristic of which is a more or less wide distribution of the relative molar mass (see DIN 55958). They have mostly an amorphous structure and usually break in a shell-like manner as a result of their very low molar mass and relatively high glass temperature (see Römpp Chemie-Lexikon, headword “resins”). According to the invention, these resins have to form homogeneous, i.e. streak-free solutions with the polyol component at 20° C. within the claimed ranges. Macroscopically, there is thus a single phase. Neither does any separation take place at 20° C. over a period of a month, preferably over a period of 6 months. On these conditions, all resins can be used, whether they be of natural or synthetic origin.

The natural resins may be of vegetable or of animal origin. The following recent resins may be mentioned in particular: shellac and colophony, be they in the form of liquid resins, gum resins or wood resins. Not only the native natural resins, but primarily their derivatives are usable, whether these be obtained by disproportionation, dimerisation, hydrogenation, polymerisation, esterification, salt formation or by addition of unsaturated compounds, for example, of maleic acid. Preferred natural resins are shellac resins and gum/colophony resins and their derivatives.

The synthetic resins are generally obtained by polymerisation or polycondensation. They characteristically do not have a sharp melting or softening point. The following may be particularly mentioned: hydrocarbon, terpene, coumarone/indene, furan, alkyd, aldehyde, ketone, phenol, glycerol ester, polyester, epoxy, urea, melamine, polyamide and isocyanate resins. Of these, hydrocarbon, terpene, alkyd, coumarone/indene, furan, aldehyde and ketone resins, as well as glycerol resin esters, are preferred.

To produce the claimed two-component polyurethane adhesive, the polyol component is first of all prepared. To this end, first of all a homogeneous solution of the resin in one or in all of the polyols is prepared by optionally heating the mixture to 100° C., with stirring. The auxiliary substances are then admixed thereto. All or part of the auxiliary substances may also be admixed to the isocyanate component. It is conventional to store these two components until they are applied in two-component form, i.e. up to the time of their application, the polyol and isocyanate components are kept separate. For the application, these two components are mixed with one another in a known per se manner and the mixture is applied to the substrates which are to be bonded together.

The polyurethane adhesives according to the invention are suitable for bonding a multitude of rigid, and in particular flexible, substrates. Thus plastics, metals, glass, textiles and above all wood and wooden materials can be bonded together, both combinations of these substrates to one another and one of these substrates to the identical substrate. By wooden materials are meant materials which are constructed chiefly of wood or which consist of wood. A distinction should be made between long-cut timber (for example, laminated wood, plywood, star plywood, three-ply wood and multi-ply wood), wooden laminated panels (for example, laminboard, blackboard, battenboard and wood core plywood), pulpwood, particle board and solid pressed wood and resin-impregnated solid wood. The adhesive is particularly suitable for the bonding of loadbearing structural members. Woods used for the latter are very hard woods, such as durmast and hawthorn; hard woods, such as beech, oak, maple, walnut; medium-hard woods, such as elm, chestnut as well as soft woods, such as larch, birch, spruce, fir and alder.

The water content of the wooden material is not usually crucial. It should be preferably in the range of 2 to 20 wt. %, in particular in the range of 4 to 16 wt. %.

The bonding is usually carried out at room temperature, under pressure, for 60 minutes at most, preferably for 30 minutes.

The bonds are distinguished by having an exceptionally high strength, which is moreover resistant to the action of moisture. In the boiling water test, not only is the chemical resistance of the bond tested, but also its mechanical resistance, as the wood may bend and warp during boiling and subsequent drying. In the process considerable stresses occur, which in the present case led rather to cracks in the wood than to cracks in the adhesive.

### EXAMPLES

1. Starting Materials

a) castor oil,

b) dipropylene glycol,

c) Voranol RA 640: a product from Dow Chemical, consisting of ethylenediamine and 4 units of propylene oxide,

d) cyclohexanone/formaldehyde resin, from Degussa-Huls AG,

e) ketone/formaldehyde resin, from Degussa-Huls AG,

f) UOP-L powder: a potassium sodium aluminum silicate of the zeolite A type, from UOP GmbH,

g) Perenol E 8: for deaeration or as a flow-control agent; is a solvent mixture with silicone component, from Cognis Deutschland GmbH,

h) calcium carbonate as filler,

i) Aerosil R 202: an amorphous highly disperse hydrophobic silicon dioxide from Degussa-Huls AG,

j) Desmodur VKS 20 F: a 4,4′-diphenylmethane diisocyanate containing polymers, from Bayer AG.

2. Preparation of the Adhesive

Firstly, the polyol component was prepared by mixing components a) to e) at 100° C. in a round-bottom flask equipped with a stirrer, with the liquid polyol components being used.

The mixture of the resin and the polyols was free from streaks.

To prepare the adhesive, the starting materials were used in the following quantities:

| STARTING MATERIAL | 1 | 2 | 3 | 4 |
|---|---|---|---|---|
| Polyol component | | | | |
| Castor Oil | 54.6 | 49.9 | 40.0 | 40.0 |
| Voranol RA 640 | — | 2.5 | 2.5 | 2.5 |
| Dipropylene glycol | — | 3.3 | 3.3 | 3.3 |
| UOP-L powder | 8.0 | 8.0 | 8.0 | 8.0 |
| Perenol E8 | 0.2 | 0.2 | 0.2 | 0.2 |
| Calcium carbonate | 35.2 | 34.1 | 34.1 | 34.1 |
| filler | | | | |
| Aerosil R 202 | 2.0 | 2.0 | 2.0 | 2.0 |
| Ketone-formaldehyde | — | — | 9.9 | — |
| resin | | | | |
| Cyclohexanone- | — | — | — | 9.9 |
| formaldehyde | | | | |
| resin | | | | |
| Isocyanate component | 24.4 | 34.3 | 35.7 | 32.1 |

Note:
amounts shown in mass %

3. Adhesive Properties

To test the adhesives in practical use, specimens in accordance with EN 205, using the adhesives of Examples 1 to 4 on beechwood rods of 2.0×10 cm in size with a 2.0×1.0 cm overlap, were employed. The other conditions were:—moisture of wood: 6%, application of adhesive: 200 g/m2, atmospheric environment: 20° C./65% relative humidity, pressing pressure: 5 bar, pressing time: 20 min., storage for curing: 7 days at room temperature (20° C.).

The combined tensile and shear strength was determined before and after the boiling water test. The boiling water test consisted in boiling the specimens in water for 24 hours and then drying them for 7 days at 60° C.

The results are summarised in the following Table:

Combined Tensile and Shear Strength (in MPa)

Example

| | 1 | 2 | 3 | 4 |
|---|---|---|---|---|
| before boiling | 5.3 | 10.0 | 13.0 | 12.9 |
| water test | | | | |
| after boiling | 2.2 | 4.8 | 12.4 | 12.0 |
| water test | | | | |

The results show that the Examples 3 and 4 according to the invention have a high combined tensile and shear strength both before and after the boiling water test. In contrast, Example 2 (corresponds to DE 44 01 572 A1) shows a sharp decrease in strength from 10.0 to 4.8 MPa.

The adhesive was soft to the touch.

4. Methods of Measurement:

a) OH value in accordance with DIN 53240,

b) preparation of specimens in accordance with EN 205.

1. A two-component polyurethane adhesive for wooden materials comprising components A and B wherein
A) is:
a polyol mixture, containing at least
a) 10 to 98 wt. % of at least one oleochemical polyol,
b) 1 to 7.5 wt. % of at least one diol having a hydroxyl value of 400 to 2000 and
c) 1 to 7.5 wt. % of at least one tri-, tetra- or pentafunctional polyol having a hydroxyl value of 200 to 2000, the wt. % of each of a), b) and c) based on the whole of the polyol mixture, and
B) is:
at least one polyisocyanate, wherein the NCO/OH ratio of components A) and B) is within the range of 1.5 to 0.9, and
further comprising from 0 to 85 wt. %, based on the total weight of the adhesive, of at least one auxiliary substance;
wherein the polyol mixture contains up to 60 wt. %, based on the total weight of the polyol mixture, of a resin homogeneously dissolved therein.

2. The adhesive of claim 1 wherein the resin is a natural resin.

3. The adhesive of claim 2 wherein the natural resin is a gum colophony or shellac resin, or derivatives thereof.

4. The adhesive of claim 1 wherein the resin is a synthetic resin.

5. The adhesive of claim 4 wherein the synthetic resin is a hydrocarbon, terpene, alkyd, furan, coumarone-indene, aldehyde or ketone resin, or a glycerol resin ester.

6. The adhesive of claim 1 wherein the oleochemical polyol comprises at least one polyol selected from the group consisting of castor oil, dimeric diols and polyols prepared by ring opening of epoxidised triglycerides of an olefinically unsaturated mixture of fats using alcohols.

7. The adhesive of claim 6 wherein the at least one polyol is castor oil.

8. The adhesive of claim 1 wherein the diol is at least one diol selected from among the alkanediols having 2 to 6 C atoms.

9. The adhesive of claim 8 wherein the alkanediols having 2 to 6 C atoms are selected from the group consisting of 1,4-butanediol, dipropylene glycol and diglycol.

10. The adhesive of claim 1 wherein the tri-, tetra- or pentafunctional polyol comprises at least one polyol selected from the group consisting of glycerol, pentaerythritol, propoxylated, ethoxylated ethylenediamine, and a tetraol.

11. The adhesive of claim 1 wherein the polyisocyanate is an aliphatic, cycloaliphatic or aromatic isocyanate having a functionality of 2 to 4.

12. The adhesive of claim 1 wherein the auxiliary substance is selected from the group consisting of fillers, catalysts, flow-control agents, and deaerating agents.

13. A method of bonding wooden materials comprising applying to the wooden materials to be bound the adhesive of claim 1.

14. The method of claim 13 wherein the wooden materials are loadbearing wooden structural members.

15. The method of claim 13 wherein the water content of the wooden material during bonding is from 2 to 20 wt. %.
